(19) United States
(12) Patent Application Publication
(10) Pub. No.: US 2009/0311492 A1
(43) Pub. Date: Dec. 17, 2009

(54) PLASTIC SHELL WITH PRINTING PATTERNS AND METHOD FOR FORMING THE SAME

(76) Inventors: Da-Sen LIN, Taichung (TW); Chien-Liang LIN, Taichung (TW)

Correspondence Address: PATENTTM.US, P. O. BOX 82788, PORTLAND, OR, 97282-0788, US

(21) Appl. No.: 12/139,821

(22) Filed: Jun. 16, 2008

(51) Int. Cl. B32B 3/02; B05D 1/36

(52) U.S. Cl. 428/195.1; 427/265

(57) ABSTRACT

A plastic shell with printing patterns has a plastic body, a printing layer and a plating layer. The plastic body has an outer surface and an area. The printing layer is attached to the outer surface of the plastic body to form the printing patterns and has an area smaller than that of the plastic body. The plating layer is attached to the outer surface of the plastic body at a region beside the printing layer.

### BACKGROUND OF THE INVENTION

1. Field of the Invention

The present invention relates to a shell, and more particularly to a plastic shell with printing patterns and a method for forming the same.

2. Description of Related Art

A plastic shell is widely applied in electrical, electronic, communication or traffic applications and always has patterns, such as trademarks to decorate or distinguish the applications. To form patterns on a conventional plastic shell, an adhesive paper/film with patterns is used. However, the conventional way of forming patterns on plastic shell with adhesive paper has the following drawbacks.

1. When the adhesive paper cannot be attached flatly onto the outer surface of the plastic shell, bubbles easily occur between the outer surface of the plastic shell and the adhesive paper. However, the bubbles cause the patterns not smooth and unaesthetic to the appearance of the plastic shell.

2. To attach the adhesive paper to a smooth outer surface of the plastic shell is difficult, and the adhesive paper easily becomes warped due to moisture or temperature change. This also causes the appearance of the plastic shell unaesthetic.

To overcome the shortcomings, the present invention tends to provide a plastic shell to mitigate or obviate the aforementioned problems.

### SUMMARY OF THE INVENTION

The main objective of the invention is to provide a plastic shell with printing patterns and a method for forming the same. The plastic shell has a plastic body, a printing layer and a plating layer. The plastic body has an outer surface and an area. The printing layer is attached to the outer surface of the plastic body and has an area smaller than that of the plastic body. The plating layer is attached to the outer surface of the plastic body at a region beside the printing layer.

The method for forming patterns on a shell comprises acts of:

a) providing a plastic body with an outer surface.

b) printing a printing layer onto the outer surface of the plastic body;

c) coating an ink layer onto the printing layer;

d) plating to form a plating layer on the outer surface of the plastic body at a region beside the printing layer; and

e) removing the ink layer.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an application with a plastic shell in accordance with the present invention;

FIG. 2 is an enlarged perspective view in partial section of a first embodiment of a plastic shell in accordance with the present invention;

FIG. 3 is an enlarged perspective view in partial section of a second embodiment of a plastic shell in accordance with the present invention;

FIG. 4 is an enlarged perspective view in partial section of a third embodiment of a plastic shell in accordance with the present invention;

FIG. 5 is a block diagram of a method for forming a plastic shell in accordance with the present invention;

FIGS. 6 and 7 are operational perspective views in partial section showing the method for forming the plastic shell in FIG. 5;

FIG. 8 is a perspective view of an application with another embodiment of a plastic shell in accordance with the present invention;

FIGS. 9 and 10 are operational perspective views in partial section showing the method for forming the plastic shell in FIG. 8.

### DETAILED DESCRIPTION OF PREFERRED EMBODIMENT

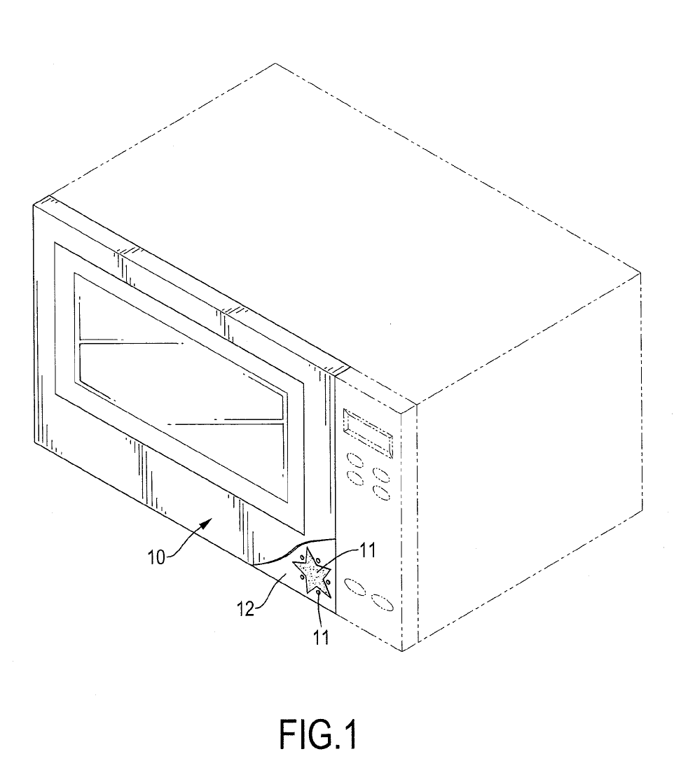

With reference to FIGS. 1 to 4, a plastic shell in accordance with the present invention comprises a plastic body (10,10A,10B), a printing layer (11,11A,1B) and a plating layer (12,12A,12B).

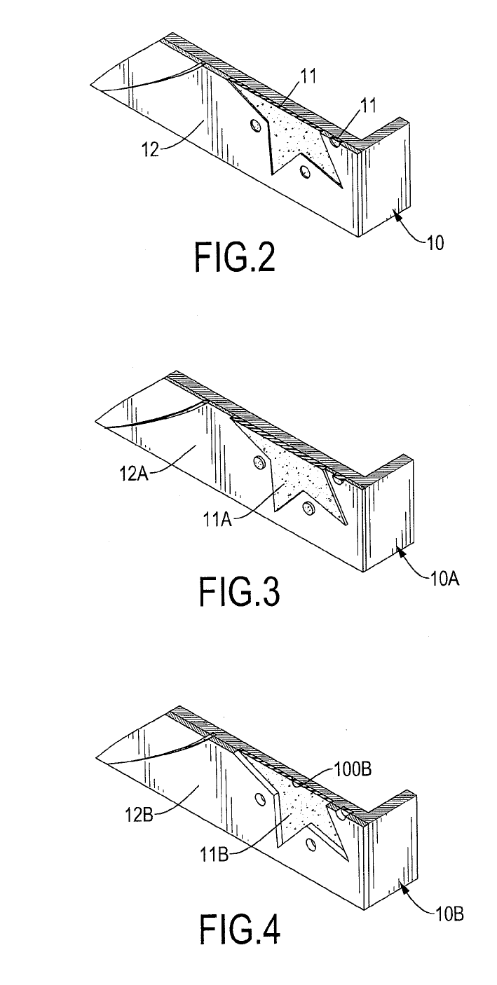

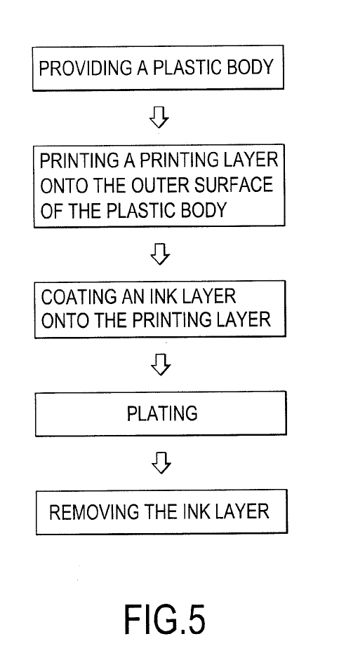

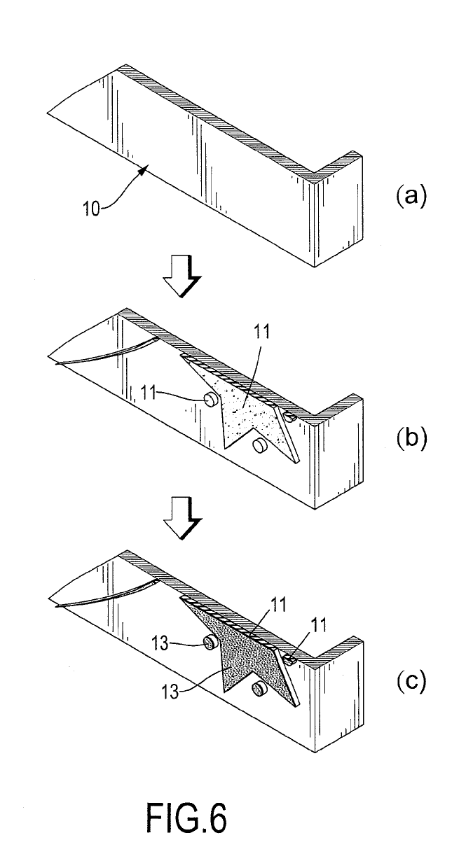

The plastic body (10,10A,10B) is made of plastic material and has an outer surface and an area. The printing layer (11,11A,11B) is attached to the outer surface of the plastic body (10,10A,10B) with a printing process in a single color or multiple colors and has an area smaller than that of the plastic body (10,10A,10B). The plating layer (12,12A,12B) is attached to the outer surface of the plastic body (10,10A,10B) with a plating process and at a region beside the printing layer (11,11A,11B). With reference to FIGS. 2 and 3, the thickness of plating layer (12,12A) may be equal to, larger or smaller than that of the printing layer (11,11A). In addition, with reference to FIG. 4, the plastic body (10B) may further have at least one cavity (100B) defined in the outer surface, and the printing layer (11B) is mounted in the cavity (100B) in the plastic body (10B).

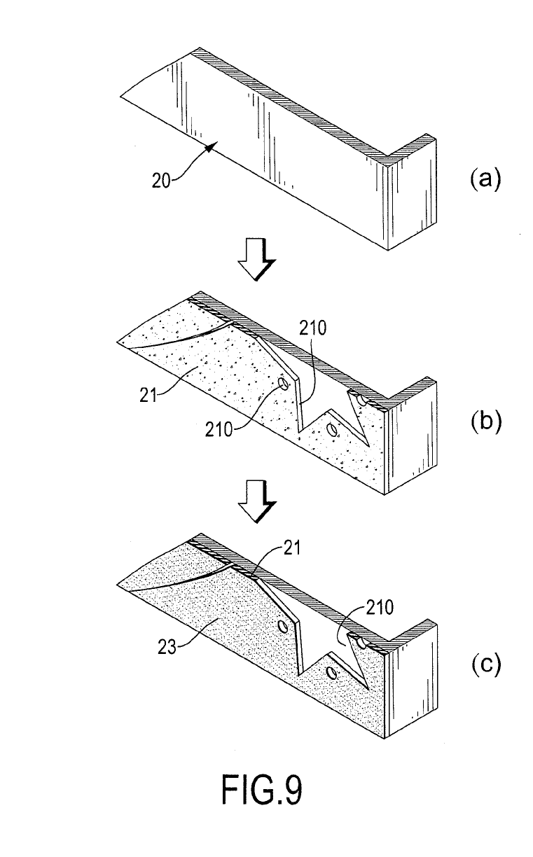

In an embodiment as show in FIG. 1, the plating layer (12,12A,12B) is mounted around the printing layer (11,11A,11B). In an alternative embodiment as shown in FIG. 8, the printing layer (21) on the plastic body (20) is mounted around the plating layer (22).

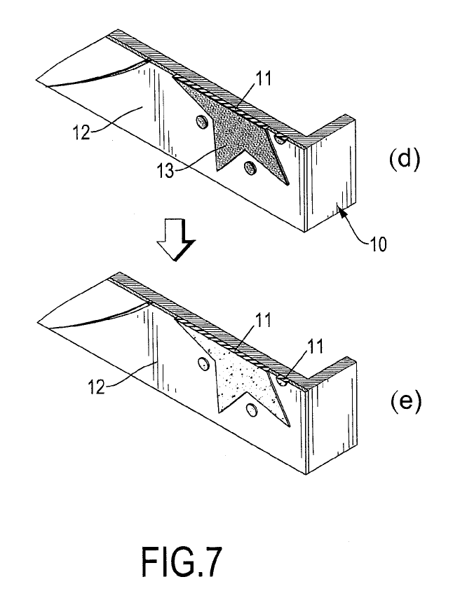

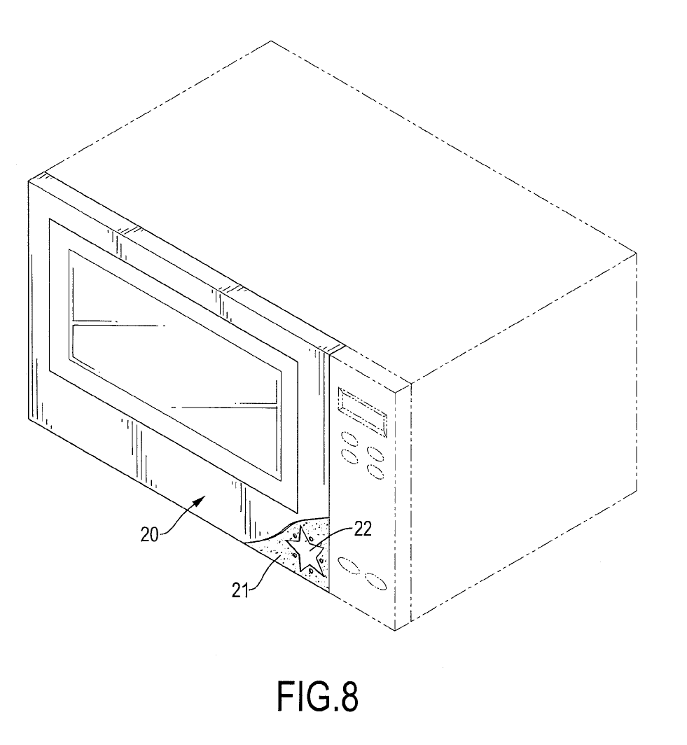

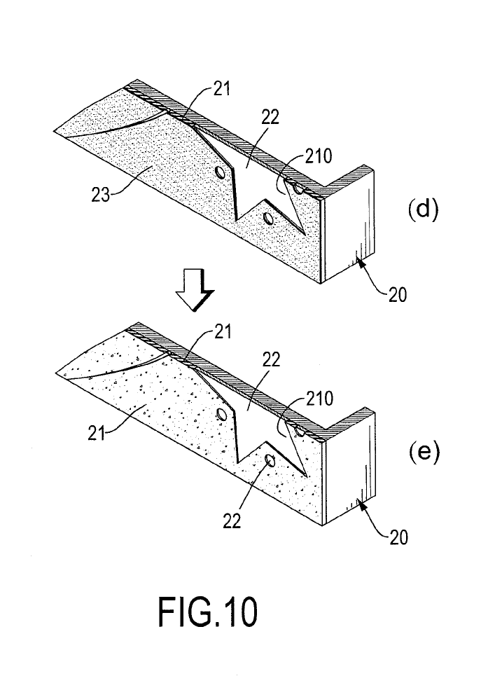

With reference to FIGS. 5 to 7, 9 and 10, a method for forming a plastic shell in accordance with the present invention comprises acts of:

a) Providing a plastic body (10,20) with an outer surface.

b) Printing a printing layer (11,21) onto the outer surface of the plastic body (10,20). The printing layer (11,21) is printed onto the outer surface of the plastic body (10,20) in a single color or multiple colors to form patterns on the plastic body (10,20).

c) Coating an ink layer (13,23) onto the printing layer (11,21). The printing layer (11,21) is covered by the ink layer (13,23).

d) Plating. Forming the plating layer (12,22) on the outer surface of the plastic body (10,20) with an electroless plating or autocatalytic plating process. Because the printing layer (11,21) is coated with the ink layer (13,23), the area of the printing layer (11,21) on the plastic body (10,20) can be kept from forming the plating layer (12,22). Accordingly, the electroplating layer (12,22) is formed on a region beside the printing layer (11,21).

e) Removing the ink layer (13,23). The ink layer (13,23) is removed to reveal the printing layer (11,21) from the outer surface of the plastic body (10,20).

Because the patterns on the plastic shell are constructed by the printing layer (11,21), the patterns can be smoothly and flatly formed on the plastic shell to make the appearance of the plastic shell aesthetic. The printing layer (11,21) is not easily even impossibly detached from the plastic shell, the plastic shell with printing patterns is durable. In addition, the thicknesses of the printing and plating layers (11,12,21,22) can be controlled to form relief or intaglio patterns on the plastic shell, such that the appearance of the plastic shell is versatile and aesthetic.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A plastic shell comprising:
a plastic body with an outer surface and an area;
a printing layer attached to the outer surface of the plastic body and having an area smaller than that of the plastic body; and
a plating layer attached to the outer surface of the plastic body at a region beside the printing layer.

2. The plastic shell as claimed in claim 1, wherein the plating layer has a thickness larger than that of the printing layer.

3. The plastic shell as claimed in claim 1, wherein the plating layer has a thickness smaller than that of the printing layer.

4. The plastic shell as claimed in claim 1, wherein the plastic body has a cavity defined in the outer surface; and
the printing layer is mounted in the cavity in the plastic body.

5. The plastic shell as claimed in claim 1, wherein the plating layer is mounted around the printing layer.

6. The plastic shell as claimed in claim 2, wherein the plating layer is mounted around the printing layer.

7. The plastic shell as claimed in claim 3, wherein the plating layer is mounted around the printing layer.

8. The plastic shell as claimed in claim 4, wherein the plating layer is mounted around the printing layer.

9. The plastic shell as claimed in claim 1, wherein the printing layer is mounted around the plating layer.

10. The plastic shell as claimed in claim 2, wherein the printing layer is mounted around the plating layer.

11. The plastic shell as claimed in claim 3, wherein the printing layer is mounted around the plating layer.

12. The plastic shell as claimed in claim 4, wherein the printing layer is mounted around the plating layer.

13. A method for forming patterns on a shell comprising acts of:
a) providing a plastic body with an outer surface.
b) printing a printing layer onto the outer surface of the plastic body;
c) coating an ink layer onto the printing layer;
d) plating to form a plating layer on the outer surface of the plastic body at a region beside the printing layer; and
e) removing the ink layer.

14. The plastic shell as claimed in claim 13, wherein the act of plating is an electroless plating process.
